(19) United States
(12) Patent Application Publication
(10) Pub. No.: US 2019/0009543 A1
(43) Pub. Date: Jan. 10, 2019

(54) LIQUID EJECTION HEAD AND LIQUID EJECTION APPARATUS

(71) Applicant: CANON KABUSHIKI KAISHA, Tokyo (JP)

(72) Inventors: Kazuya Yoshii, Yokohama-shi (JP); Koichi Kubo, Yokohama-shi (JP); Naozumi Nabeshima, Tokyo (JP); Soji Kondo, Yokohama-shi (JP); Noriyasu Nagai, Tokyo (JP)

(21) Appl. No.: 16/025,564

(22) Filed: Jul. 2, 2018

(30) Foreign Application Priority Data
Jul. 7, 2017 (JP) 2017-133997

(51) Int. Cl. B41J 2/155; B41J 2/14; B41J 2/045; B41J 2/21

(52) U.S. Cl. CPC B41J 2/155; B41J 2/14016; B41J 2/1623; B41J 2/2103; B41J 2/0458

(57) ABSTRACT

A page-wide liquid ejection head includes a liquid ejection unit 300 adapted to eject a liquid; a liquid supply unit 220 provided with a liquid supplying flow path adapted to supply the liquid to the liquid ejection unit 300; and first and second pressure control units 230 fixed to the liquid supply unit 220 and adapted to control pressure in the liquid supplying flow path, in which the first and second pressure control units 230 are shorter in longitudinal length than the liquid supply unit 220, and the first pressure control unit 230 and second pressure control unit 230 are placed by being shifted partially or totally from each other in a longitudinal direction of the liquid supply unit 220.

### BACKGROUND OF THE INVENTION

### Field of the Invention

The present disclosure relates to a liquid ejection head and liquid ejection apparatus.

### Description of the Related Art

In recent years, there has been demand for a liquid ejection apparatus capable of high-speed and high-accuracy liquid ejection. In particular, an ink-jet recording apparatus, which is an example of a liquid ejection apparatus adapted to form an image by ejecting a liquid, is expected to provide such high-speed and high-quality recording on plain paper as to be comparable to an electrophotographic recording apparatus. To do high-speed and high-quality recording on plain paper, a liquid ejection apparatus disclosed in U.S. Patent Application Publication No. 2017/050445 has a long line-type (page-wide) liquid ejection head in which plural recording element substrates (ejection chips) are arranged along an arrangement direction of plural ejection nozzles in each of the recording element substrates. In the line-type liquid ejection head, a network of liquid flow paths is formed in each recording element substrate, thereby enabling high-speed liquid ejection with the liquid being supplied at pressure managed to be within a predetermined range.

In a line-type liquid ejection head such as described above, a flow path is often formed by a long flow path member. On the other hand, to maintain stable liquid ejection, a configuration in which a liquid circulates inside the recording element substrates is desirable. Thus, the flow path is formed over an almost entire area of the long flow path member and a circulation pathway is fluidly connected with a pressure control unit and the like to generate a liquid circulating flow. A large number of joints are often provided between the circulation pathway of the long flow path member and the pressure control unit. As the joints for fluid connection between the flow path member and pressure control unit and the like, a so-called packing system may be used, where the packing system ensures sealing performance, for example, by sandwiching sealing material (packing) between the two members and compressing the sealing material using fastening power of the two members. Also, an injection-molded article, and especially a long injection-molded article, if used as the flow path member, tends to warp greatly after molding. In such a case, if a packing seal is applied to a joint for fluid connection between the long flow path member and the pressure control unit and the like, it tends to become difficult to ensure planarity of the flow path member needed to maintain sufficient sealing performance.

### SUMMARY OF THE INVENTION

An object of the present disclosure is to provide a liquid ejection head and liquid ejection apparatus which can maintain good sealing performance by inhibiting warpage of a flow path member in which a flow path is formed.

A liquid ejection head according to the present disclosure is a page-wide liquid ejection head comprising: a liquid ejection unit adapted to eject a liquid; a flow path member provided with a liquid supplying flow path adapted to supply the liquid to the liquid ejection unit; and first and second pressure control units fixed to the flow path member and adapted to control pressure in the liquid supplying flow path, wherein the first and second pressure control units are shorter in longitudinal length than the flow path member, and the first pressure control unit and second pressure control units are placed by being shifted partially or totally from each other in a longitudinal direction of the flow path member.

Further features of the present invention will become apparent from the following description of exemplary embodiments with reference to the attached drawings.

### BRIEF DESCRIPTION OF THE DRAWINGS

FIG. 1 is a perspective view illustrating a schematic configuration of a liquid ejection apparatus according to an embodiment of the present disclosure.

FIG. 2 is diagrams illustrating a circulation pathway in the liquid ejection apparatus shown in FIG. 1.

FIG. 3 is an exploded perspective view of a liquid ejection head according to the embodiment.

FIG. 4 is a perspective view of the liquid ejection head shown in FIG. 3.

FIG. 5 is an exploded perspective view of the liquid ejection head shown in FIG. 3.

FIGS. 6A, 6B, 6C and 6D are schematic plan views illustrating principal part of liquid ejection heads according to various embodiments.

### DESCRIPTION OF THE EMBODIMENTS

Preferred embodiments of the present invention will now be described in detail in accordance with the accompanying drawings.

An embodiment of the present disclosure will be described below with reference to the drawings. However, the following description is not intended to limit the scope of the present disclosure. Whereas, as an example, the present disclosure adopts a thermal method which ejects a liquid by forming air bubbles using heat-generating elements, the present disclosure is also applicable to liquid ejection heads which adopt a piezo method or any of various other liquid ejection methods.

Note that being adapted to discharge a liquid such as ink, the liquid ejection head according to the present disclosure as well as a liquid ejection apparatus equipped with the liquid ejection head are applicable to apparatuses such as a printer, copier, a facsimile machine having a communication system, and a word processor having a printer unit. Furthermore, the present disclosure is also applicable to industrial recording apparatuses compositely combined with various processing apparatuses. For example, the liquid ejection head and liquid ejection apparatus can be used for applications such as biochip fabrication, electronic circuit printing, semiconductor substrate fabrication, and 3D printing.

The liquid ejection apparatus according to the present embodiment is an ink-jet recording apparatus having a form which circulates a liquid such as ink between a tank and the liquid ejection head, but another form may be used. For example, the liquid ejection apparatus may have a form in which instead of circulating the ink, tanks are provided on upstream and downstream sides of the liquid ejection head and the ink is made to flow from one to the other of the tanks and thereby flow in a pressure chamber containing a recording element adapted to generate energy used to eject the liquid.

(Description of Ink-Jet Recording Apparatus)

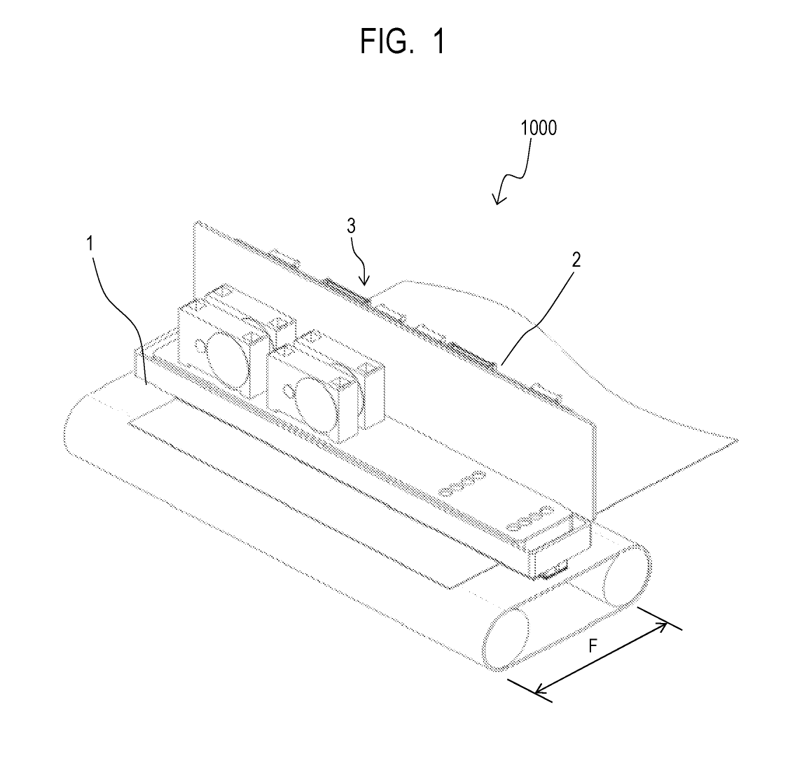

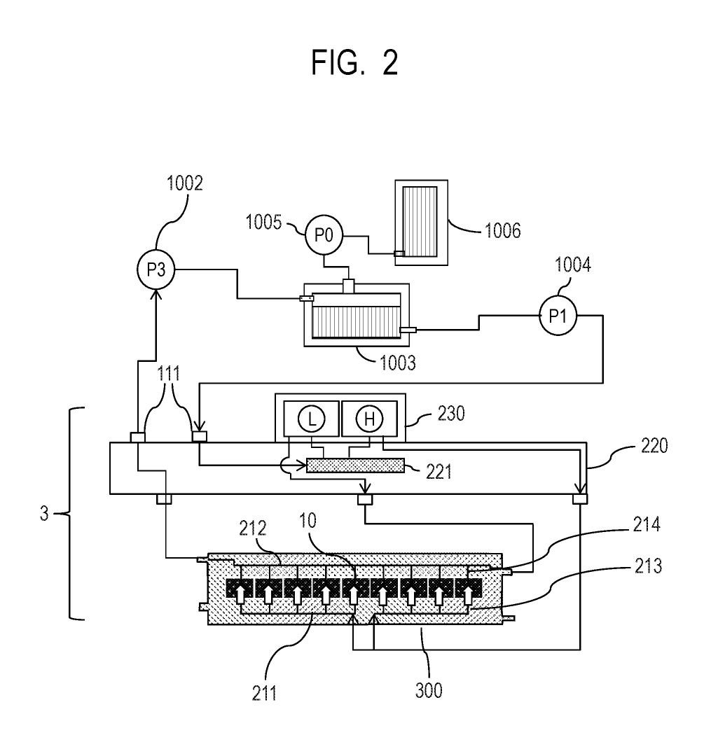

FIG. 1 illustrates a schematic configuration of the liquid ejection apparatus according to the present disclosure, and in particular, an ink-jet recording apparatus 1000 (hereinafter also referred to as a recording apparatus) which does recording by ejecting liquid ink. The recording apparatus 1000 includes a transport unit 1 adapted to transport a recording medium 2 supported at a position opposed to a liquid ejection head 3, and a line-type (page-wide) liquid ejection head 3 placed substantially at right angles to a transport direction of the recording medium 2. The recording apparatus is a line-type recording apparatus adapted to do continuous recording in a single pass while transporting plural sheets of the recording medium 2 continuously or intermittently. The recording medium 2 is not limited to cut sheets, and may be continuous roll paper. The liquid ejection head 3 is capable of full color printing using CMYK (cyan, magenta, yellow and black) inks and is fluidically connected with a liquid supply unit, main tank and buffer tank (FIG. 2), where the liquid supply unit is a supply path adapted to supply a liquid to the liquid ejection head as described later. Also, the liquid ejection head 3 is electrically connected with an electric control unit adapted to transmit electric power and an ejection control signal to the liquid ejection head 3.

(Liquid Pathway in Liquid Ejection Head)

FIG. 2 is a schematic diagram illustrating an example of a liquid pathway applied to the ink-jet recording apparatus according to the present embodiment. FIG. 2 illustrates a state in which the liquid ejection head 3 is fluidically connected to a first circulation pump (high-pressure side) 1002, a first circulation pump (low-pressure side) 1004, a buffer tank 1003 and the like. Note that although only a pathway through which one of the CMYK inks flows is shown in FIG. 2 for simplicity of explanation, actually circulation pathways for four colors are provided in the liquid ejection head 3 and liquid ejection apparatus body. The buffer tank 1003 connected to a main tank 1006 is provided with an atmosphere communication hole (not shown) adapted to communicate the inside of the tank with the outside and is capable of discharging air bubbles in the ink to the outside. The buffer tank 1003 is also connected to a replenishment pump 1005. When the liquid is consumed in the liquid ejection head 3 by being ejected (discharged) through ejection nozzles on the liquid ejection head during recording, suction recovery or the like carried out by ejecting ink, the replenishment pump 1005 transfers ink from the main tank 1006 to the buffer tank 1003 to make up for the consumption.

The first circulation pump 1004 plays a role in sucking a liquid from liquid supply/recovery connectors 111 of the liquid ejection head 3 and passing the liquid to the buffer tank 1003. A positive displacement pump having a quantitative pumping ability is desirable as the first circulation pump. Specifically, available pumps include a tube pump, gear pump, diaphragm pump and syringe pump, but a form which secures a predetermined flow rate by placing a typical constant current valve or relief valve at a pump outlet may be used alternatively. When a liquid ejection unit 300 is driven, certain amounts of ink flow through a common supply flow path 211 and common recovery flow path 212. Desirably the flow rates are set to such values that temperature differences among recording element substrates 10 in the liquid ejection head 3 will not affect recording image quality. However, if too high flow rates are set, negative pressure differences among recording element substrates 10 will become too large under the influence of pressure losses in the flow paths in the liquid ejection unit 300, resulting in density irregularities in the image. Therefore, desirably the flow rates are set by taking temperature differences and negative pressure differences among the recording element substrates 10 into consideration.

The negative pressure control unit 230 is provided on a pathway between a second circulation pump 1004 and liquid ejection unit 300. The negative pressure control unit 230 has a function to operate in such a way as to maintain pressure on a downstream side of the negative pressure control unit 230 (i.e., on the side of the liquid ejection unit 300) at a preset, constant level even if a flow rate of a circulation system fluctuates due to variation in recording duty. Any mechanisms may be used as two pressure-regulating mechanisms making up the negative pressure control unit 230 as long as the mechanisms can keep the pressure on the downstream side of the pressure-regulating mechanisms within a predetermined range around a desired set pressure. As an example, a mechanism similar to a so-called “pressure-reducing regulator” can be adopted. When a pressure-reducing regulator is used, desirably the negative pressure control unit 230 is pressurized on an upstream side by the second circulation pump 1004 via a liquid supply unit 220 as shown in FIG. 2. This enables curbing the effect of water head pressure on the liquid ejection head 3 of the buffer tank 1003, increasing the flexibility of layout of the buffer tank 1003 in the recording apparatus 1000. The second circulation pump 1004 can be of any type that has a head pressure higher than a predetermined level within a range of an ink circulation flow rate used during operation of the liquid ejection head 3, and a turbo pump, positive displacement pump and the like are available for use. Specifically, a diaphragm pump or the like can be adopted. Also, instead of the second circulation pump 1004, a water header tank placed, for example, relative to the negative pressure control unit 230 with a certain water head difference is applicable.

As shown in FIG. 2, the negative pressure control unit 230 includes two pressure-regulating mechanisms on which respective control pressures different from each other are set. Of the two pressure-regulating mechanisms, the pressure-regulating mechanism on the higher-pressure side (designated as H in FIG. 2) and the pressure-regulating mechanism on the lower-pressure side (designated as L in FIG. 2) are connected, respectively, to the common supply flow path 211 and common recovery flow path 212 inside the liquid ejection unit 300 by passing inside the liquid supply unit 220. With the circulation pathways according to the present embodiment, the liquid is supplied into the liquid ejection unit 300 by passing through the liquid supply/recovery connectors 111 of the liquid ejection head 3, the liquid supply unit 220 and two places in central part of the liquid ejection unit 300 and a place at one end of the liquid ejection unit 300 for a total of three places. Plural recording element substrates 10 are arranged in line on the liquid ejection unit 300, where each of the recording element substrates 10 has ejection nozzle rows in which plural ejection nozzles adapted to eject the liquid are arranged. The liquid passes through the common supply flow path 211 and then pressure chambers (not shown) provided on the recording element substrates 10, is recovered in the common recovery flow path 212, passes through another end of the liquid ejection unit 300, and is recovered outside the liquid ejection head 3 through the liquid supply/recovery connectors 111 of the liquid supply unit 220. A recording element adapted to generate energy used to eject the liquid is provided in each of the pressure chambers. The common supply flow path 211 and common recovery flow path 212 as well as an individual supply flow path 213 and individual recovery flow path 214 communicated with the recording element substrates 10 are provided in the liquid ejection unit 300. The individual supply flow path 213 and individual recovery flow path 214 are communicated with the common supply flow path 211 and common recovery flow path 212 and the first circulation pump 1002 generates a flow (arrows in FIG. 2) going from the common supply flow path 211 to the common recovery flow path 212 by passing through an inner flow path of the recording element substrates 10. This is because there is a pressure difference between the pressure-regulating mechanism H connected to the common supply flow path 211 and the pressure-regulating mechanism connected to the common recovery flow path 212 and because the first circulation pump 1002 is connected only to the common recovery flow path 212.

When the amount of liquid ejected from the liquid ejection head 3 increases, pressure in the common supply flow path 211 decreases due to pressure losses caused when the liquid flows through the common supply flow path 211, recording element substrates 10, and common recovery flow path 212. When the pressure in the common supply flow path 211 falls below a threshold at which the valve provided on the pressure-regulating mechanism L on the low-pressure side is opened, a liquid flow is generated only along the common recovery flow path 212.

In this way, by forming two pathway systems through which the liquid flows, the liquid can be divided between a pathway running from the common supply flow path 211 to the common recovery flow path 212 through the recording element substrates 10 and a pathway running only along the common recovery flow path 212 with increases in the amount of liquid to be ejected. This enables keeping down pressure losses.

Also, this configuration allows a flow of ink to be generated even in ejection nozzles and a pressure chamber through which the ink is not emitted during recording carried out by the liquid ejection head 3 and thereby allows thickening of the ink in that part to be inhibited. Furthermore, thickened ink as well as foreign matter in the ink can be discharged to the common recovery flow path 212. Thus, the liquid ejection head 3 according to the present application example enables high-speed, high-quality recording.

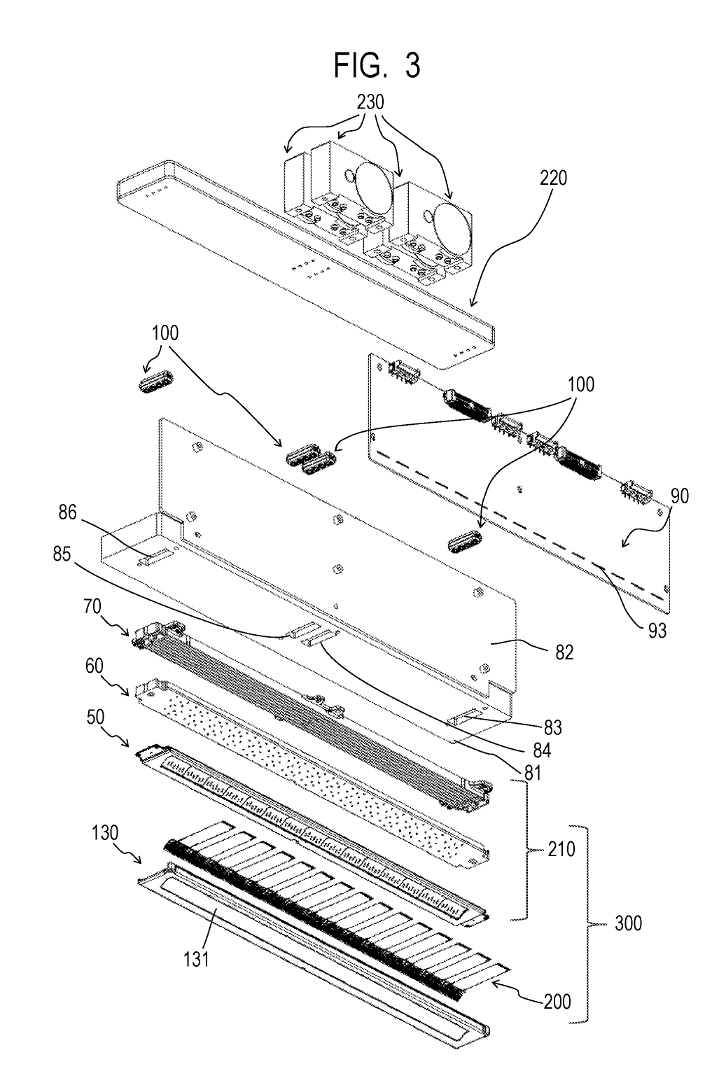

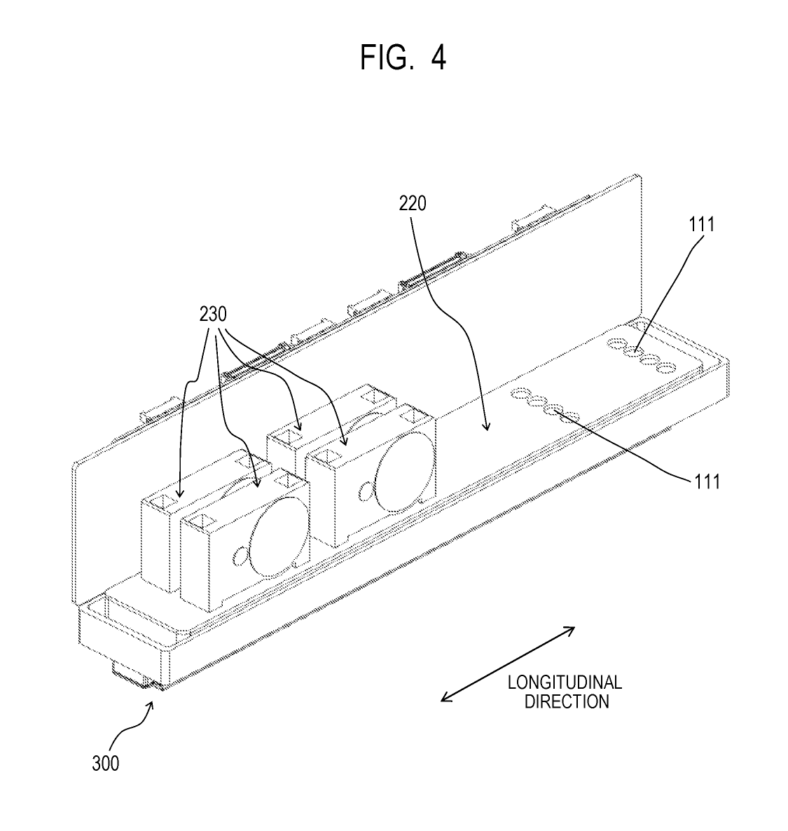

FIG. 3 illustrates an exploded perspective view of components and units making up the liquid ejection head 3. The liquid supply unit 220 is provided with the liquid supply/recovery connectors 111 (FIG. 4), and filters 221 (not shown) for respective colors are provided inside the liquid supply unit 220 by being communicated with openings in the liquid supply/recovery connectors 111 to remove foreign matter in the supplied inks. The liquid passing through the filters 221 is supplied to the color-by-color negative pressure control units 230 placed on the liquid supply unit 220. The negative pressure control units 230 include respective pressure-regulating valves independent from color to color and produce the following effects by the action of valves and spring members provided in each negative pressure control unit 230. The negative pressure control units 230 can greatly decrease pressure loss changes occurring in the supply system (supply system on the upstream side of the liquid ejection head 3) of the recording apparatus 1000 as a result of fluctuations in ink flow rates and can stabilize negative pressure changes on the downstream side of pressure control units (i.e., on the side of the liquid ejection unit 300) within a predetermined range. The negative pressure control unit 230 for each color incorporates two pressure-regulating valves for the given color as shown in FIG. 2. The two pressure-regulating valves are set to different control pressures, and via the liquid supply unit 220, the high-pressure side is communicated with the common supply flow path 211 in the liquid ejection unit 300 and the low-pressure side is communicated with the common recovery flow path 212.

A casing 80 includes a liquid ejection unit support member 81 and an electric wiring board support unit 82, supports the liquid ejection unit 300 and electric wiring board 90, and secures rigidity of the liquid ejection head 3. The electric wiring board support unit 82 is intended to support the electric wiring board 90 and is fixedly screwed to the liquid ejection unit support member 81. The liquid ejection unit support member 81 is provided with openings 83, 84, 85 and 86 into which second rubber joints (second sealing material) 100 are inserted. The liquid supplied from the liquid supply unit 220 is led to a third flow path member 70 of the liquid ejection unit 300 via the rubber joints.

The liquid ejection unit 300 includes plural ejection modules 200, a flow path member 210 and the liquid ejection unit support member 81, and a cover member 130 is mounted on a surface of the liquid ejection unit 300 on the side of the recording medium. In the liquid ejection unit 300 according to the present embodiment, plural recording element substrates 10 are arranged along an arrangement direction of the ejection nozzles, where each of the recording element substrates 10 has ejection nozzle rows in which plural ejection nozzles adapted to eject the liquid are arranged.

Next, a configuration of the intra-liquid ejection unit flow path member 210 includes in the liquid ejection unit 300 will be described. As shown in FIG. 3, the intra-liquid ejection unit flow path member 210 is a stack of a first flow path member 50, second flow path member 60 and third flow path member 70. The intra-liquid ejection unit flow path member 210 is intended to distribute the liquid supplied from the liquid supply unit 220 to the ejection modules 200 and return the liquid recirculating from the ejection modules 200 to the liquid supply unit 220. The intra-liquid ejection unit flow path member 210 is fixedly screwed to the liquid ejection unit support member 81.

The liquid supply unit 220 and negative pressure control unit 230 of the liquid ejection head 3 according to the embodiment of the present disclosure will be described with reference to FIGS. 3 to 5, where the liquid supply unit 220 is a flow path member located outside the liquid ejection unit while the negative pressure control unit 230 is a pressure control unit adapted to adjust pressure in a flow path of the flow path member. As shown in FIG. 4, the liquid supply unit 220 and negative pressure control unit 230 contain respective liquid flow paths (liquid supplying flow path and liquid recovering flow path), and the liquid flow paths make up the circulation pathways by being fluidly connected with the liquid ejection unit 300. The negative pressure control unit 230, which is capable of holding the liquid in inner space including the liquid flow paths, also functions as a sub-tank.

The liquid supply unit 220 according to the present embodiment has the shape of a substantially rectangular parallelepiped approximately equal in length (about 360 mm) to the liquid ejection unit 300. The liquid supply unit 220 and liquid ejection unit 300 are fluidly connected to each other near opposite ends and central part of the liquid supply unit 220 in a longitudinal direction via the second rubber joints 100.

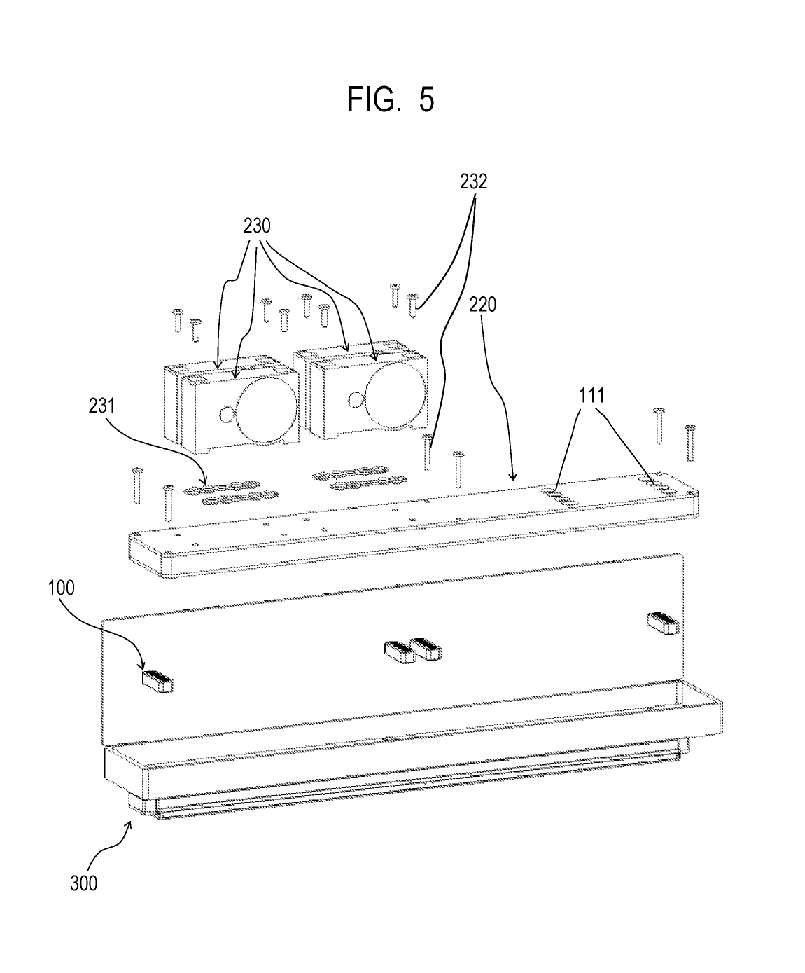

The negative pressure control unit 230 has the shape of a substantially rectangular parallelepiped shorter in length (about 70 mm) than the liquid supply unit 220 in the longitudinal direction. The negative pressure control unit 230 is provided for each color, and according to the present embodiment, four negative pressure control units 230 corresponding to four CMYK colors are provided. That is, first, second, third and fourth negative pressure control units 230 control the pressures of liquids of different types (colors), respectively. As shown in FIG. 5, each negative pressure control unit 230 is fluidly connected to the liquid supply unit 220 via first rubber joints (first sealing material) 231. Furthermore, the negative pressure control units 230 are mechanically joined to the liquid supply unit 220 by screws 232. The first rubber joints 231 exhibit sufficient sealing performance by being compressed by fastening power of the screws between the negative pressure control units 230 and liquid supply unit 220. That is, the first rubber joints 231 are compressed by being sandwiched between a sealing surface of the liquid supply unit 220 and sealing surfaces of the negative pressure control units 230, thereby cutting off the flow of liquids and gas to and from the outside.

Similarly, the above-mentioned liquid supply unit 220 and liquid ejection unit 300 are fixedly joined together by the screws 232 with the second rubber joints 100 sandwiched therebetween. The second rubber joints between the sealing surfaces of the liquid supply unit 220 and liquid ejection unit 300 are compressed by fastening power of the screws 232 between the liquid supply unit 220 and liquid ejection unit 300, thereby exhibiting sufficient sealing performance.

Principal part of the liquid supply unit 220 and negative pressure control units 230 according to the present embodiment is formed by injection molding. Generally, long injection-molded articles tend to warp greatly in the longitudinal direction due to thermal shrinkage after molding. Thus, according to the present embodiment, the plural negative pressure control units 230 are placed on the liquid supply unit 220 such that the longitudinal direction of the negative pressure control units 230 and the longitudinal direction of the liquid supply unit 220 will substantially coincide with each other. The plural negative pressure control units 230 are arranged next to one another along the longitudinal direction of the liquid supply unit 220. With this configuration, the long liquid supply unit is held down by the plural negative pressure control units 230 and is less liable to warp in the longitudinal direction. Generally, short injection-molded articles are less liable to warp than long injection-molded articles, so in the present embodiment, the negative pressure control units 230 are less liable to warp than the liquid supply unit 220. Thus, by fixing the negative pressure control units 230 less liable to warp in superposition with the liquid supply unit 220, warpage of the liquid supply unit 220 can be inhibited.

Suppose all the negative pressure control units 230 are arranged next to one another along the lateral direction on the liquid supply unit 220, the part left out from being fixed in superposition with any of the negative pressure control units 230 in the longitudinal direction of the liquid supply unit 220 increases. Because warpage of this part is hardly inhibited, the above arrangement is insufficient in preventing warpage of the liquid supply unit 220. According to the present embodiment, plural negative pressure control units 230 are fixed in superposition with the liquid supply unit 220. Besides, at least one of the negative pressure control units 230 fixed in superposition with the liquid supply unit 220 is shifted (offset) in longitudinal position from the other negative pressure control units 230. In other words, some or all of the negative pressure control units 230 are placed by being shifted from at least one of the other negative pressure control units 230 without overlapping in longitudinal position.

The negative pressure control units 230 are arranged next to one another along the longitudinal direction on the liquid supply unit 220 by being shifted partially or totally from one another in the longitudinal direction of the liquid supply unit 220. With this configuration, the liquid supply unit 220 is constrained by the negative pressure control units 230 not only in one place, but also in plural places in the longitudinal direction or in almost the entire area in the longitudinal direction. Consequently, warpage of the liquid supply unit 220 in the longitudinal direction can be inhibited effectively. Regarding a lateral direction (width direction orthogonal to the longitudinal direction) of the liquid supply unit 220, it is often the case that there is no particular need to give consideration because of small size and consequent small warpage.

As described above, in a configuration in which sealing performance is ensured by compressing the rubber joints 231 by the fastening power between two kinds of parts (negative pressure control units 230 and liquid supply unit 220), desirably the flatness and parallelism of the parts surfaces placed in contact with the rubber joints 231 are high. If the flatness or parallelism of the sealing surfaces is low, the rubber joints 231 are compressed insufficiently in some part, which might result in reduced sealing performance. Thus, by inhibiting warpage of the liquid supply unit 220 which is a long part, in particular, and thereby improving the flatness and parallelism of the sealing surfaces, the sealing performance of the liquid supply unit 220 and liquid ejection unit 300 can be improved.

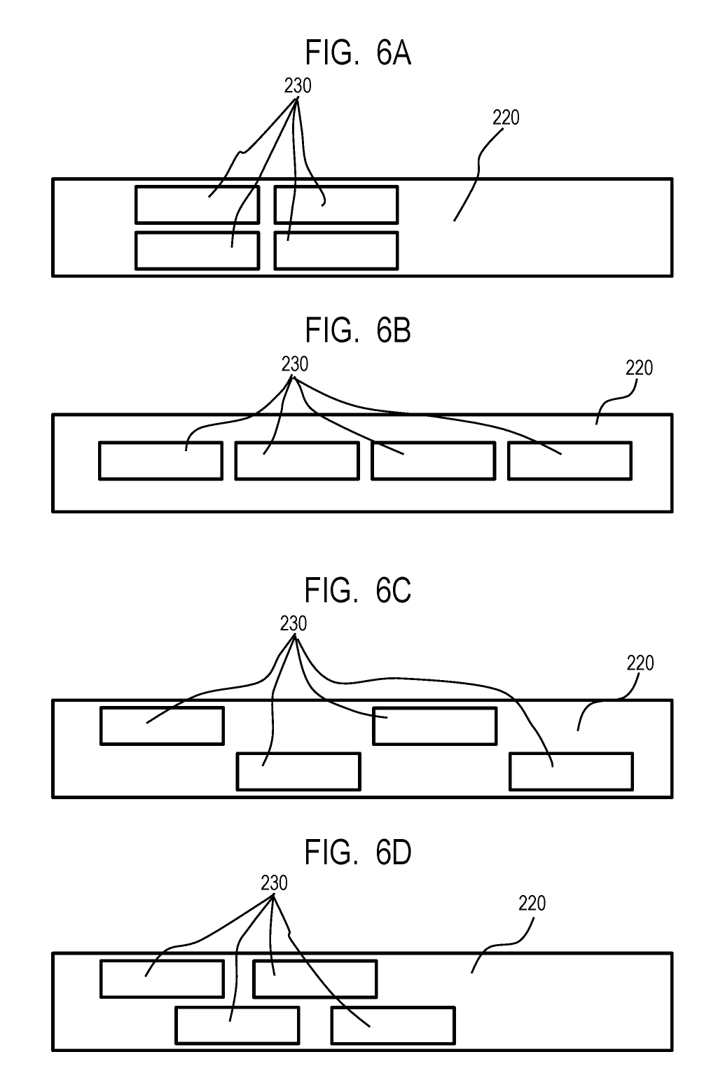

In the embodiment shown in FIGS. 1 to 5, plural negative pressure control units 230 are arranged in series in two columns, and specifically, in a 2 by 2 array as schematically shown in FIG. 6A. However, the arrangement of the negative pressure control units 230 is not limited to such an array, and various layouts are available. For example, as shown in FIG. 6B, the plural negative pressure control units 230 may be arranged in series in a single column. Also, as shown in FIG. 6C, the plural negative pressure control units 230 may be arranged in two columns in a staggered manner. As shown in FIG. 6D, a staggered arrangement similar to the one shown in FIG. 6C may be set up only in part of the liquid supply unit 220. The warpage prevention effect is increased when the negative pressure control units 230 are provided over the entire length of the liquid supply unit 220 in the longitudinal direction. However, for convenience of layout such as a layout intended to avoid interference of the liquid ejection head 3 with outer members, space devoid of the negative pressure control units 230 may be provided in part of the liquid supply unit 220 in the longitudinal direction as shown in FIGS. 6A and 6D.

To enhance the effect of the present disclosure, desirably the negative pressure control units 230 are low in warpage and high in flexural rigidity. Therefore, for example, by increasing the height and lateral width of the negative pressure control units 230, the flexural rigidity of the negative pressure control units 230 in the longitudinal direction may be increased. Such a high flexural rigidity of the negative pressure control units 230 provides an effect whereby the negative pressure control units 230 function as reinforcement members against bending of the liquid supply unit 220. After the negative pressure control units 230, liquid supply unit 220 and liquid ejection unit 300 are assembled, even if heat deformation occurs as a result of linear expansion or contraction due to various factors, the negative pressure control units 230 inhibit deformation of the liquid ejection unit 300 by playing the role of beams. Also, when the liquid supply unit 220 includes a portion partially reduced in strength due to a functional structure, if the negative pressure control units 230 are arranged in such a way as to compensate for the strength reduction, the liquid supply unit 220 can be kept from being reduced in strength.

The method for fixing the liquid supply unit 220 and negative pressure control units 230 to each other is not limited to the screws 232, and various fixing methods are available for use. For example, a method may be adopted which uses latches such that fastening power will act between the two kinds of members 220 and 230. Also, although in the present embodiment, warpage of the liquid supply unit is inhibited using the negative pressure control units 230 functioning as a pressure control unit, this configuration is not restrictive. For example, a sub-tank which is simply an ink reservoir not intended for negative pressure control may be provided instead of the negative pressure control units 230 described above.

As described so far, according to the present disclosure, the negative pressure control units 230 (pressure control units) shorter in longitudinal length than the liquid supply unit 220 (flow path member) are relatively low in warpage after molding. Consequently, as the plural negative pressure control units 230 are fixed by being aligned with the liquid supply unit 220 in the longitudinal direction, any warpage of the liquid supply unit 220 can be corrected. Furthermore, as the plural negative pressure control units 230 are arranged in series and fixed to the liquid supply unit 220 by being aligned with the liquid supply unit 220 in the longitudinal direction, warpage of the liquid supply unit 220 can be inhibited effectively. Besides, at least one of the negative pressure control units 230 fixed to the liquid supply unit 220 is placed by being shifted partially or totally in position from the other negative pressure control units 230 in the longitudinal direction of the liquid supply unit 220. Also, some or all of the negative pressure control units 230 are placed by being shifted from at least one of the other negative pressure control units 230 without overlapping in position in the longitudinal direction of the liquid supply unit 220. Consequently, warpage of the liquid supply unit 220 in the longitudinal direction can be inhibited effectively.

Also, since the rubber joints 231 generate a sealing force by being subjected to a compression force resulting from the fastening power produced when the negative pressure control units 230 are fixed to the liquid supply unit 220 with screws 232 or the like, sealing performance between the two kinds of members can be ensured using a simple configuration. Such a configuration for fastening and sealing is similarly applicable to fastening and sealing between the liquid supply unit 220 and liquid ejection unit 300. With the configuration in which the negative pressure control units 230 are placed at positions between plural pieces of a sealing material in the longitudinal direction of the liquid supply unit 220, the sealing performance of the rubber joints 100 can be further improved.

In relation to the liquid ejection head, the present disclosure enables maintaining good sealing performance by inhibiting warpage of the flow path member in which the flow path is formed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-133997, filed Jul. 7, 2017, which is hereby incorporated by reference herein in its entirety.

What is claimed is:

1. A page-wide liquid ejection head comprising: a liquid ejection unit adapted to eject a liquid; a flow path member provided with a liquid supplying flow path adapted to supply the liquid to the liquid ejection unit; and first and second pressure control units fixed to the flow path member and adapted to control pressure in the liquid supplying flow path,
wherein the first and second pressure control units are shorter in longitudinal length than the flow path member, and
the first pressure control unit and second pressure control unit are placed by being shifted partially or totally from each other in a longitudinal direction of the flow path member.

2. A page-wide liquid ejection head comprising: a liquid ejection unit adapted to eject a liquid; a flow path member provided with a liquid supplying flow path adapted to supply the liquid to the liquid ejection unit; and first and second pressure control units fixed to the flow path member and adapted to control pressure in the liquid supplying flow path,
wherein the first and second pressure control units are shorter in longitudinal length than the flow path member, and
some or all of the first pressure control units are placed by being shifted from the second pressure control units without overlapping in position in the longitudinal direction of the flow path member.

3. The liquid ejection head according to claim 1, wherein the first and second pressure control units are fixed to the flow path member by being aligned with the flow path member in longitudinal direction.

4. The liquid ejection head according to claim 1, wherein the first and second pressure control units are arranged in series and fixed to the flow path member by being aligned with the flow path member in longitudinal direction.

5. The liquid ejection head according to claim 1, wherein the flow path member and each of the first and second pressure control units are joined together via a first sealing material such that the liquid supplying flow path in the flow path member and a space inside the pressure control units are fluidly connected with each other.

6. The liquid ejection head according to claim 5, wherein the first sealing material generates a sealing force by being subjected to a compression force resulting from fastening power produced when the first and second pressure control units are fixed to the flow path member.

7. The liquid ejection head according to claim 1, wherein the flow path member and the liquid ejection unit are joined together via a second sealing material such that the liquid supplying flow path in the flow path member and a flow path inside the liquid ejection unit are fluidly connected with each other.

8. The liquid ejection head according to claim 7, wherein the second sealing material generates a sealing force by being subjected to a compression force resulting from fastening power produced when the liquid ejection unit is fixed to the flow path member.

9. The liquid ejection head according to claim 8, wherein at least one of the first and second pressure control units is placed at a position between a plurality of pieces of the second sealing material in the longitudinal direction of the flow path member.

10. The liquid ejection head according to claim 1, further comprising third and fourth pressure control units adapted to control pressure in the liquid supplying flow path, wherein:
the third and fourth pressure control units are shorter in longitudinal length than the flow path member; and
some or all of the third pressure control units are placed by being shifted from the fourth pressure control units without overlapping in position in the longitudinal direction of the flow path member.

11. The liquid ejection head according to claim 10, wherein the third and fourth pressure control units are arranged in series and fixed to the flow path member by being aligned with the flow path member in longitudinal direction.

12. The liquid ejection head according to claim 1, wherein the flow path member includes a liquid recovering flow path adapted to recover the liquid from the liquid ejection unit.

13. The liquid ejection head according to claim 12, wherein the first and second pressure control units control pressure of the liquid supplying flow path and pressure of the liquid recovering flow path.

14. The liquid ejection head according to claim 10, wherein the third and fourth pressure control units control pressure of the liquid supplying flow path and pressure of the liquid recovering flow path.

15. The liquid ejection head according to claim 10, wherein the first, second, third and fourth pressure control units control pressures of different types of liquid, respectively.

16. The liquid ejection head according to claim 1, wherein a plurality of recording element substrates is arranged in line on the liquid ejection unit, each of the recording element substrates including an ejection nozzle row in which a plurality of ejection nozzles adapted to eject the liquid is arranged.

17. The liquid ejection head according to claim 1, wherein the liquid ejection unit includes a pressure chamber containing a recording element adapted to generate energy used to eject the liquid, and the liquid in the pressure chamber is circulated into and out of the pressure chamber.

18. A liquid ejection apparatus comprising: the liquid ejection head according to claim 1; and a transport unit adapted to support and transport a recording medium to a position opposed to the liquid ejection head.
